(19) United States
(12) Patent Application Publication
(10) Pub. No.: US 2026/0065907 A1
(43) Pub. Date: Mar. 5, 2026

(54) METHOD AND APPARATUS FOR VOICE RECOGNITION ERROR CORRECTIONS

(71) Applicant: HUAWEI TECHNOLOGIES CO., LTD., Shenzhen (CN)

(72) Inventors: Wei Zhou, Brampton (CA); Shung Hei Lynn, Brampton (CA); Wei Li, Markham (CA); Hui Shyong Yeo, Markham (CA); Manpreet Singh Takkar, Markham (CA); Umarpreet Singh, Brampton (CA)

(73) Assignee: HUAWEI TECHNOLOGIES CO., LTD., Shenzhen (CN)

(21) Appl. No.: 19/069,071

(22) Filed: Mar. 3, 2025

Related U.S. Application Data
(60) Provisional application No. 63/690,159, filed on Sep. 3, 2024.

(51) Int. Cl. G10L 15/22; G06V 30/418; G10L 15/18

(52) U.S. Cl. CPC G10L 15/22; G06V 30/418; G10L 15/1815; G10L 2015/221

(57) ABSTRACT

There is provided a method for correcting text produced by an Automatic Speech Recognition system. The method comprises receiving a voice command, determining an intent to correct from the voice command, classifying the type of correction as either a replacement, an addition, or a deletion, and determining the type of correction information provided as either structural, contextual, semantic, or retrieval based. Based on the type of correction and the type of correction information, a corrected text is determined using Large Language Models (LLMs) or a database.

### CROSS-REFERENCE TO RELATED APPLICATIONS

The present application claims priority from U.S. Patent Application No. 63/690,159, filed Sep. 3, 2024 and incorporated herein by reference.

### FIELD OF THE DISCLOSURE

The present disclosure relates to Automatic Speech Recognition (ASR) systems. Specifically, the present disclosure relates to a method and apparatus for correcting errors made by ASR systems.

### BACKGROUND

Despite the generally faster rate of user speech compared to typing, the adoption of voice input in practical applications remains limited. One primary obstacle hindering widespread usage is the inherent propensity for errors in voice input systems, such as Automatic Speech Recognition (ASR) systems, particularly when confronted with ambiguous voice input such as homophones, which can lead to semantic confusion and transcription inaccuracies. Furthermore, voice input systems often struggle with the recognition of Out-of-Vocabulary (OOV) words, including less common names, technical terms, and domain-specific jargon, which can compromise the overall accuracy and reliability of speech transcription.

### SUMMARY

The present disclosure relates to an improved solution for correction speech recognition errors.

According to a first aspect there is provided a method for correcting an original text comprising receiving a command in natural language, determining that the command is a correction command, classifying the correction command as an addition, a replacement, or a deletion, when the correction command is an addition or a replacement, determining new text based on the correction command, determining a correction location in the original text; and performing the correction to the original text. By handling a correction command in natural language, the process of correcting text produced by ASRs is made much easier from the user's point of view.

According to an embodiment of the first aspect, said determining that the command is a correction command comprises detecting a secondary input during said receiving the command. The secondary input may be used to indicate that a command is a correction command.

According to another embodiment of the first aspect, the secondary input is a button press.

According to yet another embodiment of the first aspect, the secondary input is a cursor movement to a portion of the original text.

According to yet another embodiment of the first aspect, said determining that the command is a correction command comprises providing to a first Large Language Model (LLM) the original text, the command, and the cursor movement, and determining that the command is a correction command based on an output of the first LLM. The first LLM may be used to classify the command as a correction command.

According to yet another embodiment of the first aspect, the method further comprises determining a description type for command, the description type being one of structural, contextual, semantic, or augmented retrieval. The classification of the command as structural, contextual, semantic, or augmented retrieval enables the method to properly interpret the requested correction.

According to yet another embodiment of the first aspect, said determining a description type comprises providing to a first Large Language Model (LLM) the original text, the command, and the cursor movement and determining the description type based on an output of the first LLM. The first LLM may be used to classify the command as structural, contextual, sematic, or augmented retrieval.

According to yet another embodiment of the first aspect, said determining the new text comprises, when the command is structural: providing the command to a first Large Language Model (LLM) for extracting structure and pronunciation information from the command, and looking up a structural database based on the structure and pronunciation information. Structure and pronunciation information extracted from the command using an LLM is used to determine the new text.

According to yet another embodiment of the first aspect the structural database is a dictionary.

According to yet another embodiment of the first aspect the structural database is a character database.

According to yet another embodiment of the first aspect said determining the new text comprises when the voice command is contextual: providing the command to a first Large Language Model (LLM) for extracting contextual words from the command, extracting pronunciation information from the command, and selecting the new text from the command based on the contextual words and the pronunciation information. The first LLM may extract contextual words from the command, and the new text may be determined based on the contextual words and extracted pronunciation information.

According to yet another embodiment of the first aspect the method further comprises finding candidate words which match the pronunciation information, computing a contextual affinity between the candidate words and the contextual words, and selecting as the new text the candidate words with the greatest contextual affinity with the contextual words.

According to yet another embodiment of the first aspect, computing the contextual affinity comprises using at least one of a second Large Language Model (LLM) or a word and phrase database.

According to yet another embodiment of the first aspect said determining the new text comprises when the command is semantic: providing the command to a first Large Language Model (LLM) for extracting semantic information from the command, extracting pronunciation information from the command, finding candidate words which match the pronunciation information and querying the first LLM to identify candidate words which match the semantic information. The first LLM may be used to extract semantic information from the command. The first LLM may then use extracted pronunciation information and the semantic information to find candidate words which match the extracted semantic information.

According to yet another embodiment of the first aspect said determining the new text comprises when the voice command is augmented retrieval: providing the command to a first Large Language Model (LLM) for extracting information identifying a digital object from the command, retrieving the digital object, analyzing the digital object to determine the new text. The first LLM may be used to identify a digital object from the command, and this digital object may be used to determine the new text.

According to yet another embodiment of the first aspect the digital object is a phonebook application and said analyzing the digital object comprises matching text fields from entries in the phonebook application to the pronunciation information.

According to yet another embodiment of the first aspect the digital object is an image and said analyzing the digital object comprises providing the image to an object detection model to identify names of objects in the image, and matching the names of the objects in the image to the pronunciation information.

According to yet another embodiment of the first aspect said determining the correction location comprises identifying a cursor position relative to a portion of the original text. Cursor position may be used to identify a correction location.

According to a second aspect there is provided a computing device comprising a processor and memory, the computing device being configured receive a command in natural language, determine that the command is a correction command, classify the correction command as an addition, a replacement, or a deletion, when the correction command is an addition or a replacement, determine new text based on the correction command, determine a correction location in the original text; and perform the correction to the original text.

According to a third aspect, there is provided a computer readable medium having stored thereon for execution by a processor of a computing device, the executable code comprising instructions for receiving a command in natural language, determining that the command is a correction command, classifying the correction command as an addition, a replacement, or a deletion, when the correction command is an addition or a replacement, determining new text based on the correction command, determining a correction location in the original text; and performing the correction to the original text.

### BRIEF DESCRIPTION OF THE DRAWINGS

FIG. 1A is a graphical representation of an error in Automatic Speech Recognition (ASR) systems, according to at least some embodiments of the present disclosure.

FIG. 1B is a graphical representation of a correction process according to at least some embodiments of the present disclosure.

FIG. 2 is a flowchart of a method for determining correction intent according to at least some embodiments of the present disclosure.

FIG. 3 is a flowchart of a method for determining a correction command type according to at least some embodiments of the present disclosure.

FIG. 4 is a flowchart of a method for processing a correction when the correction command type is structural according to at least some embodiments of the present disclosure.

FIG. 5 is a flowchart of a method for processing a correction when the correction command type is contextual according to at least some embodiments of the present disclosure.

FIG. 6 is a flowchart of a method for processing a correction when the correction command type is semantic according to at least some embodiments of the present disclosure.

FIG. 7 is a flowchart of a method for processing a correction when the correction command type is retrieval-augmented description.

FIG. 8 is a flowchart of a method for correcting errors made by ASR systems according to at least some embodiments of the present disclosure.

FIG. 9 is a schematic diagram showing an Artificial Intelligence (AI) engine, wherein the AI engine comprises a Large Language Model (LLM).

FIG. 10A is a schematic diagram showing an encoder-based LLM.

FIG. 10B is a schematic diagram showing a decoder-based LLM.

FIG. 10C is a schematic diagram showing an encoder-decoder-based LLM.

FIG. 11 is a block diagram of computing device according to at least one embodiment of the present disclosure.

### DETAILED DESCRIPTION

The present disclosure seeks to provide an improved solution for correcting speech recognition errors, by addressing some or all of the limitations of the prior art. Specifically, the present disclosure introduces a novel system designed to provide users with an effortless, intuitive, and natural means of correcting errors made in speech transcription, as well as editing and refining previously transcribed text.

In particular, the present disclosure seeks to provide a solution which allows a user to provide a command to correct a section of text using natural language, where natural language refers to language that is used naturally by humans, as opposed to, e.g., programming languages.

Conventional voice input systems employed in the industry may provide users with the option to spell out specific words, such as names, one character at a time, as a means of ensuring accurate transcription. However, correcting errors in these systems often necessitates repeating the entire spoken phrase, which can be inefficient and time-consuming. Furthermore, these systems typically only permit the use of a limited, predefined set of voice commands, such as ‘delete’, ‘replace’, or ‘undo’, to make basic modifications to previously transcribed text. These commands are often rigidly defined and do not offer the flexibility or granularity required to effectively correct errors or edit text in a more sophisticated manner.

When a voice input system fails to accurately identify a segment of speech, correcting the error may pose challenges. The user is typically forced to adopt one of two cumbersome approaches: either repeat the entire utterance, or manually delete the incorrect portion and rephrase the relevant section. This process is particularly arduous when the misrecognized speech segment contains specific information, such as proper nouns, which are often crucial to the accuracy and context of the communication. In such cases, the user's only viable alternatives are to resort to manual keyboard entry or painstakingly enunciate each individual character, as exemplified by spelling out a name letter by letter (e.g., W-E-I-Z-H-O-U). Furthermore, in instances where homophones are involved, the ASR system's bias towards a particular linguistic interpretation can lead to incorrect recognition, making it difficult for the user to rectify the error. This can significantly detract from the overall interaction experience, introducing frustration and diminishing the effectiveness of the speech-based interface.

Hence, current voice input systems often lack support for seamless correction of text errors, such as ambiguous voice input, and those that do provide correction capabilities rely on rigid rules, which restrict the use of natural commands and limit the system's robustness and discoverability. Furthermore, these systems typically do not leverage touch-based input to simplify the voice command process for correcting text errors, resulting in a less intuitive and less effective user experience.

The present disclosure proposes a novel solution to the problem of editing and correcting transcribed text and correcting text errors through speech, addressing the limitations of existing voice input systems. By introducing a more flexible and natural language-based editing paradigm, the system may help enable users to modify either a portion or the entirety of the transcribed text using intuitive voice commands. Furthermore, the application provides a unique approach to correcting homophones and near-homophones in both Chinese and English languages, leveraging voice input to accurately disambiguate between words with similar pronunciations. Additionally, the system incorporates a mechanism for users to provide contextual information about their attention or areas of interest within the existing text, utilizing touch or other pointing input modalities to facilitate more precise and efficient editing operations.

The present disclosure supports language instructions for the correction of text errors such as text ambiguity errors (e.g. homophones), while helping to ensure high reliability and consistency with structural processing on top of a Large Language Model's (LLM) language understanding capability. The present disclosure also provides specialized methods for determining a replacement text for a text error from various natural descriptions of the replacement text, including structural, contextual, and semantic descriptions.

Further, in some embodiments, touchscreen or cursor information may be used to convey a user's correction intention and simplifying voice correction commands. Specifically, a change in cursor location may indicate an intention to make a correction, as well as providing a location for editing. Thus, cursor location may be used to indicate a correction location when multiple possible candidate locations exist. In some embodiments, a user's correction intention may be determined by a button press, or simply based on the content of the voice command.

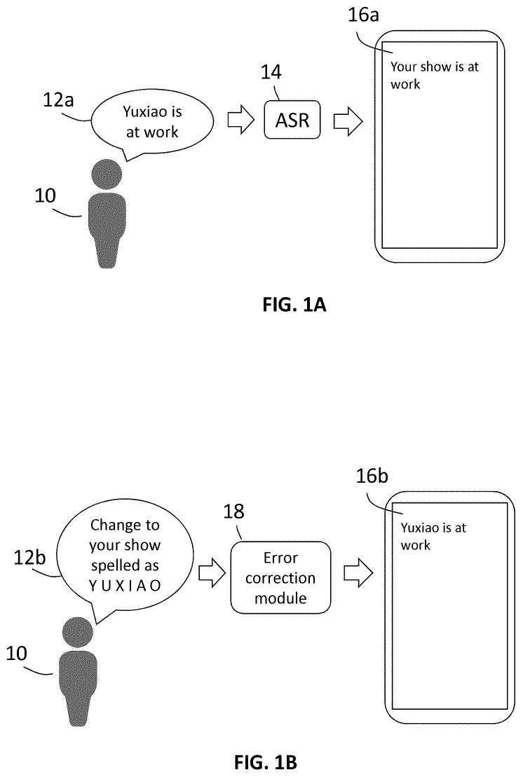

Reference is made to FIG. 1A and FIG. 1B, which illustrate general concepts of the present disclosure.

As seen in FIG. 1A, a person 10 speaks a phrase 12a which is picked up by a microphone (not shown) and processed by an ASR system 14. However, the phrase contains the term ‘Yuxiao’ which is a Chinese name that is not recognized correctly by ASR 14. Instead of the correct phrase ‘Yuxiao is at work’, ASR 14 produces the incorrect phrase ‘your show is at work’ 16a, because ASR 14 misconstrued ‘Yuxiao’ as ‘your show’.

As seen in FIG. 1B, person 10 may then instruct an error correction module 18 to correct phrase 16a by speaking a correction command 12b. In this example, the correction command is ‘change to your show spelled as Y U X I A O’, where ‘your show’ is the incorrect transcription of the original text by ASR 14.

Upon receiving correction command 12b, error correction module 18 may produce the correct phrase, 16b.

Various embodiments of error correction module 18 shall now be described.

LLMs can comprehend language nuances and long-range contextual dependencies, enabling them to make informed predictions that maximize coherence and accuracy. The proposed solution seeks to leverage this capability of LLMs to introduce flexibility in allowed commands while maintaining high consistency and accuracy. By harnessing the ability of LLMs to infer the most suitable word or phrase for editing, the solution can exploit additional context whenever available. This contextual information can encompass various forms of data, including neighboring text, additional decoded states from a voice recognition (e.g. ASR) system, description of edits provided by user and other relevant metadata. The present application relates to specialized tools tailored to the correction and editing tasks in voice typing, by breaking down the complex problem of error correction into manageable sub-problems. This approach enables the system to tackle each sub-problem in a targeted and efficient manner, ultimately enhancing the overall accuracy and effectiveness of the voice typing system.

According to at least some embodiments, an error correction module may first determine whether the user intends to make a correction to a text produced by an ASR module.

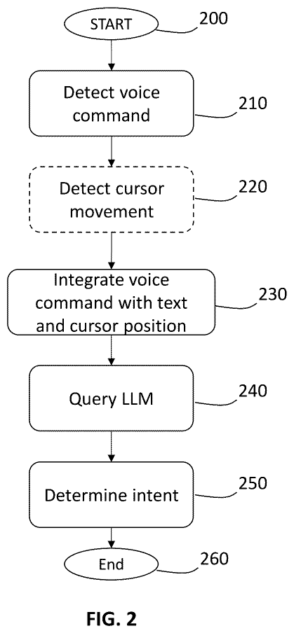

Reference is made to FIG. 2, which shows a method for determining whether the user intends to make a correction according to at least some embodiments of the present disclosure. The context for the method of FIG. 2 is after an ASR module on a computing device produced a text based on speech, the text is displayed on a display of the computing device, and the user may need to make a correction to the text.

The method of FIG. 2 starts at block 200 and proceeds to block 210 where a voice command is captured. For instance, in the example illustrated in FIGS. 1A and 1B, the user can express their intention to edit using a variety of spoken phrases, such as ‘Change to your show spelled as Y-U-X-I-A-O’ or ‘your show spelled as Y-U-X-I-A-O’, without being constrained by a predefined template.

A correction voice command may be provided with a secondary input. The secondary input may be an explicit indication that the voice command is a correction command or a strong indication that the voice command is a correction command. Examples of explicit indications include, without limitation, a correction command button, if for example the user device comprises such a button. In this case, any speech input with the correction command button is treated as a correction command. Examples of strong indications include a cursor movement to the text produced by the ASR module. Without an explicit indication, a user may simply express in normal language a correction command related to the text produced by the ASR module.

Once a voice command is captured, the method optionally proceeds to block 220, where a cursor movement is detected. Specifically, in some embodiments, the user may move the cursor to select or point to a section of text to be corrected. In other embodiments, cursor movement may not be monitored and only the voice command may be used to determine the intention of the user.

Generally, a change in the cursor's location is a strong indication of an intention to edit. By identifying a specific portion of the ASR's output, a cursor movement can effectively localize the editing operation, ensuring accurate and efficient modifications to the text. Once the region of interest in the text is identified, the method may extract the closest relevant text and utilize it as additional contextual information to precisely determine editing parameters, such as the specific text string to be added, replaced, or deleted. The cursor movement may be based on a mouse, or a touch screen, or any other peripheral used to detect cursor movements. If the cursor is moved to a position at or near where the text is displayed, it may be deemed a relevant cursor movement, to be used in determining whether the user intends to make a correction. Alternatively, if the cursor is not moved or if is moved to a position which is not near where the text is displayed, it may not be deemed to be a relevant cursor movement, and the cursor movement will not be used in determining whether the user intends to make a correction.

The method then proceeds to block 230, where all available contextual data is integrated to create a query for the LLM. According to at least some embodiments, the contextual data may comprise, without limitation, the text produced by the ASR, the voice command, and the cursor position. The method then proceeds to block 240 where the LLM is queried.

The LLM may then use the existing text, the new voice command, and optionally a cursor position, to decide whether the new phrase is an instruction to correct the existing text or if it is just the next sentence to be transcribed by the ASR module.

According to at least some embodiments, an LLM may be used as a classifier, where the classifier is trained to output an intent. According to at least some other embodiments, a foundation model may be fine-tuned with text-editing data, and used to generate a response or to generate a structured output comprising intent.

Upon receiving the LLM's output, the method proceeds to block 250 where the intent of the user is determined, and the method ends at block 260. The intent of the user may be either to perform a correction, or not. For example, if the user does not intend to perform a correction, the voice command may be treated as text to be processed by the ASR module.
If it is determined that the intent of the user is to correct the text produced by the ASR, the next step is to determine the type of correction the user wants to be made. As will be described in greater detail below, the type of correction may be one of addition, deletion, or replacement.

For instance, the user may want to replace a portion of the original text produced by the ASR with a replacement text, insert new text into the original text produced by the ASR, or delete a portion of the original text produced by the ASR. Each of these types of corrections has its own set of associated parameters that need to be extracted and processed. For example, in the case of a replacement edit, the parameters could include the string to be replaced in the original text and the new text to replace it with. For an insertion edit, the parameters could include the new string to be added and the location where it should be inserted. The correction location can be specified explicitly through the correction command or implicitly through additional modalities such as touch or mouse pointing. However, in some cases, the correction location may not be explicitly stated and it may be necessary to deduce it based on language understanding and contextual information. For a deletion edit, the parameters would include the portion of the original text to be deleted.

The user's description of the correction may be structural, contextual, or semantic. Structural information refers to the spelling of words (in languages with alphabets such as English), or to structural components of a character such as a Chinese character. Contextual information refers to additional context which may help disambiguate a homophone. For example, “flour” and “flower” may be disambiguated based on contextual information such as “flour as in wheat flour”. Semantic information refers to the meaning of the words used, and such information on the meaning of an ambiguous word or a homophone may be used to determine the intended word. In at least some embodiments, the user's description of the correction may refer to information stored on the computing device, or to a digital object which is accessible by the computing device. As non-limiting examples, the digital object may be an entry in a contact book, or an image displayed on a screen of the computing device.

Where the text error relates to homophones, as in the example shown in FIGS. 1A and 1B, the voice command may comprise a structural description of the homophones to facilitate editing and error correction. For example, in the case of proper nouns, the user might provide the correct spelling of the word, such as ‘Change to your show spelled as Y-U-X-I-A-O’. This structural information, namely referring to “your show” in the sentence produced by the ASR module, and the correct spelling of the proper noun ‘Yuxiao’, combined with pronunciation information derived from both the original speech and transcribed text, enables the system to extract the necessary information required to perform edits accurately. The pronunciation is indicated by the transcribed text “your show”, which is used for locating the text to correct with similar pronunciation in the original input, and for validating the intended text with similar pronunciation in the correction command. Additionally, pronunciation information from the original speech may be used to more precisely match the pronunciation information.

According to some embodiments, where the language is Chinese, the command may be “ [symbol] ”, meaning “change to the character ‘ [symbol] ’ with ‘ [symbol] ’ as a structural component” which specifies a structural component “ [symbol] ” of the intended correct character “ [symbol] ”. This structural information, namely pointing to “ [symbol] ” in the sentence produced by the ASR module, and the structural component “ [symbol] ” for the correct intended character ‘ [symbol] ’, as in the English case, combined with pronunciation information derived from both the original speech and transcribed text “ [symbol] ”, enables the system to extract the necessary information required to perform edits accurately.

The pronunciation information can be obtained from a single output from the speech recognition system or from a beam of probable outputs, which are then further processed and refined. In instances where multiple output candidates of the speech recognition system match the character description and pronunciation, for example in the case of languages like Mandarin, a default candidate can be assigned based on the most common or likely pronunciation.

The correction command contained in the voice input may provide additional contextual information that may help to disambiguate the intended edit. For instance, when a homophone is misrecognized by the ASR module, the information included in a correction command can provide the surrounding context in which the misrecognized word is used. The surrounding context may comprise words that are generally used in conjunction with the misrecognized word, but not with its homophones. This contextual information may be important in resolving the ambiguity created by the homophones. For example, if the ASR system mistakenly transcribes the word ‘flour’ as ‘flower’ in the text, the user's instruction can provide additional context to clarify the intended meaning, such as ‘flour as in wheat flour’, or ‘flour as in this recipe calls for one cup of flour’. The additional words like ‘wheat’, ‘cup, and ‘recipe’ represent contextual information which are more closely associated to the word ‘flour’ than ‘flower’. By incorporating this contextual information, the system can more accurately determine the correct term to be used, for example, in the replacement text, and apply the correction accordingly.

According to some embodiments, where the language is Chinese, a contextual correction in Chinese may be “ [symbol] ”,meaning “‘ [symbol] ’ as in the word ‘ [symbol] ’”, which specifies the intended correct character “ [symbol] ” by providing a word context where it is used. The pronunciation information given by the transcribed text “ [symbol] ” is used to match the pronunciation of the character to correct in the original text and the correct character “ [symbol] ” in the contextual description.

In some cases, the user may provide additional semantic information to clarify the intended meaning of the misrecognized term. For instance, if the ASR system mistakenly transcribes the word ‘cache’ as ‘cash’, the user can provide a corrective instruction that incorporates semantic data, such as ‘change it to the computer memory term cache’. By providing semantic information that the term in question is a computer technology term, the user can help disambiguate the intended meaning and enable the system to accurately correct the misrecognized term. This approach allows the user to leverage their domain-specific knowledge and provide semantic information that can aid in resolving the ambiguity.

According to some embodiments, where the language is Chinese, a semantic correction command may be “ [symbol] ”, meaning “change to the character ‘ [symbol] ’ that means the province Henan”. This specifies the meaning of the character “ [symbol] ” which has the same pronunciation as the transcribed character “ [symbol] ”.

In yet some other cases, users may utilize a retrieval-augmented approach to describe misrecognized words. The retrieval-augmented approach involves the user specifying a digital object which is retrieved and used to assist in the correction. For instance, if the name of a person is misrecognized in the transcribed text, it may be corrected by saying ‘correct it to your show, the contact in my phone book’. Alternatively, users may ask for information to be retrieved from various sources, such as on-screen data or camera-captured images. For example, if the word ‘pear’ is misrecognized as ‘pair’, the user may instruct the system to perform the correction by saying ‘pear as in the one present in this image on screen’. By leveraging text data or image data, the system can effectively disambiguate the user's intent and instruction, which may lead to more accurate and efficient error correction. The information from an image may be retrieved using an independent vision model such as an object detection model, or it could be extracted with a multimodal LLM such as a Vision Language Model (VLM).

The description provided by the user may be integrated with other intermediate information, including beam transcriptions predicted by, for example, an Automatic Speech Recognition (ASR) module and filter words based on phoneme similarity in the speech. Specifically, the ASR module may produce a set of possible transcriptions, each with an associated confidence score, allowing the system to consider various interpretations of the speech input. This set of possible transcriptions may be used to identify a correction location, or to identify the intended text.

A language understanding module or pipeline, such as, for example, an LLM, can be employed to leverage the structural, contextual, and semantic information, in conjunction with the pronunciation features from the speech, to extract the target text description and determine the correction location. In some embodiments, a module or pipeline may be trained to utilize the combined information from various sources to identify the intended correction location and description.

According to at least some embodiments of the present disclosure, once the intention to edit has been confirmed, the method comprises classifying the correction command according to one of the above categories, namely structural, contextual, semantic, or retrieval-based.

This may be performed by first extracting relevant information, for example, the original text produced by the ASR module, the correction command, and optionally a cursor position. This information may then be provided to an LLM which then outputs one of the above categories.

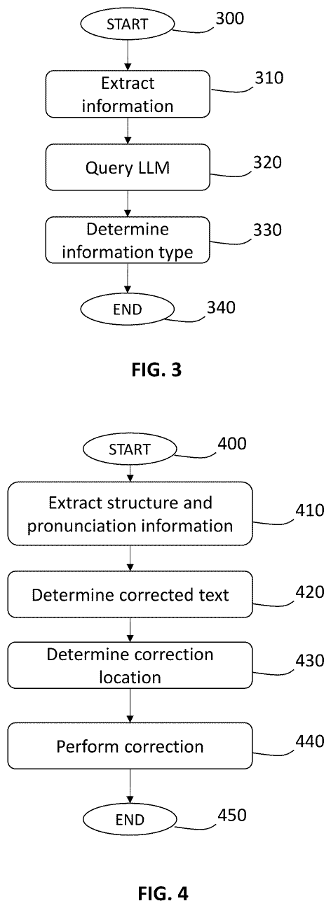

Reference is now made to FIG. 3, which illustrates a method for determining the type of correction information provided in the correction command.

As seen in FIG. 3, the method starts at block 300 and proceeds to block 310, where relevant information is extracted. The relevant information may comprise, without limitation, the contextual information including the surrounding text or the recent corrections, the correction command, the original text produced by the ASR module, and a cursor position, if any.

The information extracted at block 310 is then passed to an LLM at block 320. The LLM may in this case be used to determine a type of correction information. For example, the type of correction information may be structural, contextual, semantic, or retrieval-based.

Upon receiving the LLM output, the type of correction may be determined at block 330. The method then ends at block 340.

Reference is now made to FIG. 4, in which a method for processing the correction with structural information is illustrated.

As seen in FIG. 4, the method starts at block 400 and proceeds to block 410 where the structural and pronunciation information is retrieved. The structural information may comprise a snippet of text to be replaced in the original text produced by the ASR module. For example, in the above example where the correction command is ‘Change to your show spelled as Y-U-X-I-A-O’, the structural information comprises the spelling of the corrected text.

In this case, the pronunciation of the correct word is represented by the similar sound incorrectly transcribed word “your show”. In another example with the Chinese correction instruction, “ [symbol] ” (English translation: change to the character ‘ [symbol] ’ with “ [symbol] ” as a structural component), the pronunciation is repeated in the edit instruction, represented by the incorrectly transcribed character “ [symbol] ”. The pronunciation information may also be further derived from the output of the ASR module corresponding to the audio data for the replacement text to further evaluate candidates with pronunciation close to that of the correct word. This pronunciation may be represented by text such as a phrase or a Chinese character, or the phonetic representation of the text. The phonetic representation maybe a sequence of symbols such as pinyin in the Chinese case, or a vector embedding from an AI model.

The method then proceeds to block 420 where the corrected text is determined. In some embodiments, this may comprise providing the pronunciation information to a structural database, such as a dictionary, or a character structural database (for example, a database of structural components of Chinese characters), to retrieve the corrected text. In some cases, where there remains ambiguity, such as for example when a pronunciation may correspond to more than one Chinese character, the most common or probably Chinese character may be selected.

The method then proceeds to block 430, where the location of the correction is determined. According to at least some embodiments, a language understanding module is trained to identify an edit location from all available information, such as the original text produced by the ASR module, the correction command, and the cursor position. The language understanding module may be an LLM, or a small language model trained for this specific purpose.

According to at least some embodiments, a model is trained for function calling, allowing it to generate structured output, such as an intent to correct and parameters for the correction. According to at least some embodiments, a model is trained to tag each token (i.e., word or character) in the original transcribed text or in the correction command. Non-limiting examples of tags may include “text to be replaced”, and “replacement text”.

Function calling in large language models (LLMs) involves training the model to identify a specific function (or functions) that should be executed based on the input context. This requires the model to generate structured outputs, such as a function name (e.g., “text correction”) and corresponding parameters (e.g., “replacement text” and “text to be replaced”). This can be done for general purpose function calling. In this method the LLM may be provided with a list of allowed functions and the input parameters for these functions, as well as the description of what each function does. This information may be provided with additional context such as the original text from the ASR module and the user command, and the LLM may return a structured output which can be parsed to extract a function name and its parameters. Alternatively, the LLM may be fine tuned using methods such as supervised fine tuning, to work for a specific use case. For example, the list of functions used to make edits may be fixed at the outset, and the model may be fine tuned to predict the function names and required parameters without the need to provide the list of functions to the model.

Once the correction location is determined, the method proceeds to block 440 where the correction is performed. Specifically, the original text produced by the ASR module is modified by either adding new text, deleting a portion of text, or replacing some text with new text, according to the correction parameters determined from the voice command. The method then ends at block 450.

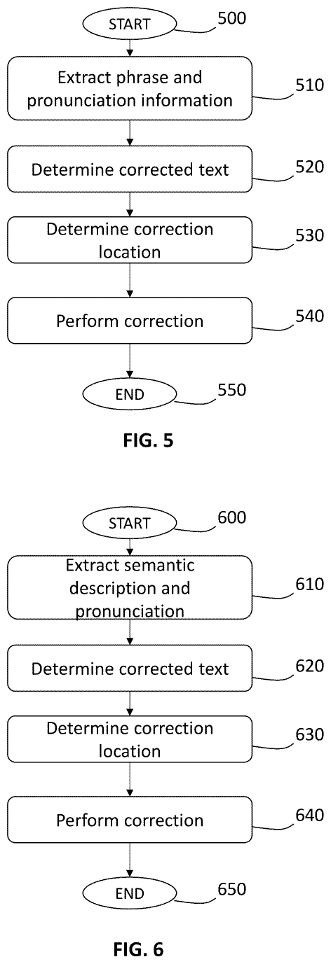

Reference is now made to FIG. 5, which shows a method for processing a correction with contextual information.

The method of FIG. 5 starts at block 500 and proceeds to block 510 where word or phrase contextual information and pronunciation information is extracted. This information may include information derived from the original voice input provided to the ASR module, as well as information derived from the correction command.

According to at least some embodiments, the information extracted at block 510 comprises at least one of the following: pronunciation information for an ambiguous word, and contextual words.

In embodiments where the Chinese language is used, the pronunciation of each character is represented by a single pinyin. For each pinyin, there is a fixed set of characters which may be used as candidates. For example, for the pinyin ‘YU’, the following characters may be candidates: [symbol] , [symbol] , [symbol] , [symbol] , [symbol] .

The method then proceeds to block 520 to determine the corrected text. In particular, at block 520, the method may use the information extracted at block 510 to provide contextual links between different words. Thus, at block 520, the method is used to identify a replacement term for a word or a phrase in the original text. The candidate words may then be evaluated based on their contextual affinity to the contextual words. For example, in the case where the original ASR text mistakenly transcribed “flour” as “flower”, and the correction command includes “flour as in wheat flour”, the candidate words could be “flour” and “flower”, and the contextual word is “wheat”. In this scenario, the candidate word “flour” would have greater contextual affinity with “wheat” than “flower”. The determination of which candidate word has greater contextual affinity with contextual words may be determined using a word and phrase database in some embodiments, or an LLM in other embodiments. A word and phrase database may comprise a dictionary of all words in a language, supplemented with phrases in which such words are used. The word and phrase database may be stored locally on the user device, or at a remote location, accessible by the user device through a network such as a local area network or a wide area network such as the Internet.

In embodiments where the Chinese language is used, the correction command “ [symbol] ”, meaning “‘ [symbol] ’ as in the word ‘ [symbol] ’”, “ [symbol] ” specifies the usage context of the intended character “ [symbol] ”, which has the same pronunciation as the character ‘ [symbol] ’ in the transcribed instruction.

The method then proceeds to block 530 to determine the correction location. The correction location may be determined based on at least one of the original voice input, a cursor location, and the correction command. Using the above example, assuming the intended input was “add one cup of flour”, and was transcribed by the ASR module as “add one cup of flower”, the user may use the edit instruction “change to flower as in wheat flour”, which in addition to the usage context, specifies the word in the transcribed text to correct has pronunciation similar to “flower”.

The method then proceeds to block 540 to perform the correction, and the method ends at block 550. Specifically, the original text produced by the ASR module is modified by either adding new text, deleting a portion of text, or replacing some text with new text, according to the correction parameters determined from the voice command.

Reference is now made to FIG. 6, in which a method for processing a correction with semantic information is illustrated.

The method of FIG. 6 starts at block 600 and proceeds to block 610 where semantic information and pronunciation information is extracted. In particular, semantic information may be extracted from the correction command. For example, assuming the intended input was “it is stored in the cache”, and the output of the ASR module was “it is stored in the cash”, the correction command may be “change cash to the term associated with computer memory”. The word “cash” in the correction command provides the pronunciation information of the intended word, and the pronunciation information of the incorrect word in the original text.

In this case, the semantic information that may be extracted at block 610 may be “the term associated with computer memory”.

The method then proceeds to block 620 to determine the new text. Specifically, at block 620, the semantic information extracted at block 610 is provided to an LLM, which uses the provided semantic information and pronunciation information to find an appropriate replacement text. For example, when the correction command is “change cash to the term associated with computer memory”, the pronunciation information for “cash” is provided to the LLM along with “computer memory term”, allowing the LLM to determine that the corrected text should be “cache” instead of “cash”.

Alternatively, instead of passing the pronunciation information to an LLM, the pronunciation information may be used to find a list of candidate words such as “cache” and “cash” using a pronunciation dictionary or database. The LLM may then be queried to find which of the candidate words matches the semantic information.

In embodiments where the Chinese language is used, the correction command “ [symbol] ”, meaning change “‘ [symbol] ’ to the character correspond to ‘ [symbol] ’”,“ [symbol] ” specifies the semantic meaning of the intended character “ [symbol] ”, which has the same pronunciation as the character ‘ [symbol] ’ in the transcribed instruction.

The method then proceeds to block 630 to determine the correction location. The correction location may be determined based on at least some of the original voice input, the correction command, and a cursor position, or other methods described herein.

The method then proceeds to block 640 to perform the correction, and the method ends at block 650. Specifically, the original text produced by the ASR module is modified by either adding new text, deleting a portion of text, or replacing some text with new text, according to the correction parameters determined from the voice command.

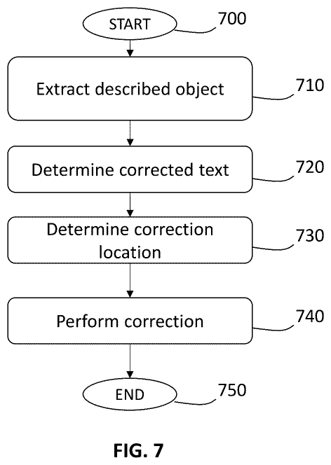

Reference is now made to FIG. 7, which shows a method for processing a correction based on a retrieval augmented description command.

The method starts at block 700 and proceeds to block 710 where the reference object is extracted. Specifically, the reference object is a digital object referenced in the correction command to assist the system in correcting the text. An LLM may be trained to identify digital objects from a correction command of the augmented-retrieval type. The identity of the digital object may be expressed as a Uniform Resource Locator (URL), a memory location, or an application name, as non-limiting examples. The LLM may further be trained to specify the type of the digital object (e.g., picture, audio file, text file, application data, etc.). If no digital object identified by the correction command is found, an error message may be output. If multiple digital objects are found, in some embodiments, all digital objects are retrieved and analyzed, or in other embodiments, one digital object is selected at random.

Once the reference object is identified and retrieved, the method proceeds to block 720 to determine the corrected text. Specifically, the reference object identified at block 710 is retrieved and analyzed based on its type.

In some cases, the reference object may be a contact in a user's contact book, as in ‘Correct it to your show, the contact in my phone book’. The correction command may then be provided to the LLM to identify the phonebook application, and the pronunciation information for ‘your show’ may be used to identify a data entry within the phonebook application which is a best match. In the present example, this would be the entry for ‘Yuxiao’, and ‘Yuxiao’ may then be selected as the new text.

In some other cases, the reference object may be a picture currently displayed on a screen. For example, if the word “pear” was transcribed as “pair”, and the image currently displayed on the screen is of a pear, the correction command may be “pear as in the one present in this image on screen”. The correction command may then be provided to the LLM to identify the image. An independent vision model such as an object detection model may then be used to extract a list of words describing objects in the image. In some embodiments, the vision model may be a multimodal LLM such as a Vision Language Model (VLM). The list of words may then be matched to the pronunciation information to find the best match.

The method then proceeds to block 730 to determine the correction location. The correction location may be determined based on at least some of the original voice input, the correction command, and a cursor position, or other methods described herein.

The method then proceeds to block 740 to perform the correction, and the method ends at block 750. Specifically, the original text produced by the ASR module is modified by either adding new text, deleting a portion of text, or replacing some text with new text, according to the correction parameters determined from the voice command.

In some embodiments, the location of the text error may be determined and extracted from various input modalities, such as touch, mouse pointing or other pointing mechanisms and the like. For example, a change in cursor location can be a strong indication of intention of editing. By identifying a specific area or region of a user's input, the system may be able to localize the editing operation, helping to ensure accurate and efficient modifications to the text. Once the text error in the existing text is identified, the system may extract the closest relevant text and utilize it as additional contextual information to precisely extract the editing parameters. These parameters, such as a specific text string to be added, replaced, or deleted (i.e. target text), may then be determined. Furthermore, the location of the user's touch or pointing input can be used to determine the exact location within the text where the editing operation should be applied. In cases where multiple instances of the identified word or phrase exist, the system may intelligently determine which instance is closest to the user's input location, helping to ensure that the correct instance is edited. This approach may enable precise and targeted editing operations, helping to enable simpler and more efficient commands, reducing errors and improving overall user experience.

This method of identifying the text to be corrected may be used in conjunction with methods described above or separately.

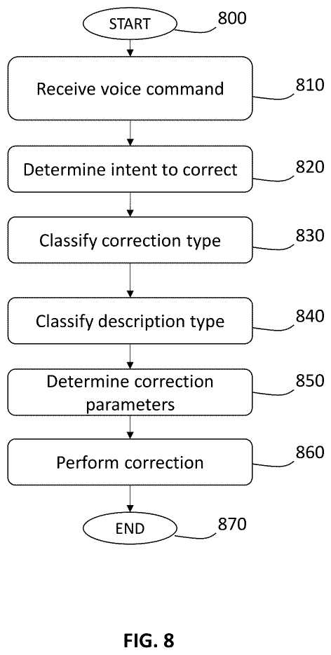

Reference is now made to FIG. 8, showing a method for correcting text according to at least some embodiments of the present disclosure. Although not shown in FIG. 8, the context at the beginning of the method of FIG. 8 is that an ASR module transcribed text based on an original voice command.

The method starts at block 800 and proceeds to block 810 where a voice command is received. This voice command is distinct from the original voice command mentioned above, and may comprise further data to be processed by the ASR module, or a command to correct the text transcribed by the ASR module from the original voice command. The voice command is typically received through a microphone integrated or connected with the user device.

A voice command within the context of the present disclosure is any command that is spoken with the intent to communicate with the ASR module or to correct the output of the ASR module, which is received at the user device. The voice command may be in natural language, where natural language is a language that humans use to communicate with each other.

The method then proceeds to block 820 to determine whether the received voice command is a correction command. A correction command is a command to correct the text previously transcribed by the ASR module, as opposed to having the ASR module transcribe more text.

The determination that the received voice command may be based on methods described herein, such as for example, the method described in FIG. 2.

Upon determining that the received voice command is a correction command, the method then proceeds to block 830 where the correction type is determined. Specifically, the correction may be an addition, a deletion, or a replacement. According to at least some embodiments, an LLM may be employed as a classifier, to classify the correction command as one of addition, deletion, and replacement.

The method then proceeds to block 840 where the description type is determined. The description type refers to the type of information is included in the correction command to provide the parameters for the correction. As discussed above, in at least some embodiments, the description type may be one of structural, contextual, semantic, or augmented-retrieval, however this is not intended to be limiting. The determination of the description type may be based on methods described herein, such as for example, the method described in FIG. 3.

The method then proceeds to block 850 where the edit parameters are determined. In particular, the correction location and any new text (in cases of a replacement or an addition) is determined. The correction location refers to the location, in the original text produced by the ASR module, where the correction should be made.

As discussed above, according to at least some embodiments, the method used to determine the edit parameters may be based on the description type identified at block 840. Thus, when the description type is structural, the method of FIG. 4 may be used, when the description type is contextual, the method of FIG. 5 may be used, when the description type is semantic, the method of FIG. 6 may be used, and when the description type is augmented-retrieval, the method of FIG. 7 may be used.

The method then proceeds to block 860 where the correction is performed. Specifically, the original text produced by the ASR is edited by either adding, deleting, or replacing text according to the edit parameters identified at block 850. The method then proceeds to block 870 and ends.

Foundation models (FMs) or language models (LMs) such as Large Language Models (LLMs) are computational models used for language generation and other natural language processing, such as text classification. Some LLMs may obtain these abilities by learning the statistical relationship between language tokens through intensive training procedures. With the rapid growth of model size, transformer-based LLMs have shown results in domains such as, for example, instruction following, coding assistance, and creative writing. Among these tasks, unlocking the rationality of LLMs to solve complex reasoning tasks remains a major challenge. Recent works have attempted to tackle this challenge through Supervised Fine-Tuning (SFT). By mixing crafted new reasoning data samples with original datasets, LLMs learn the underlying distributions of these samples and attempt to mimic the logic they have learned to solve unseen reasoning tasks. Although there is a performance gain, this method heavily relies on extensive training and requires extra data preparation.

Large language models (LLMs) are neural network models that learn the semantics and syntax of language by encoding words or subwords into vector representations. These models are trained on extensive datasets and are widely used in various artificial intelligence (AI) applications, including text generation, sentiment analysis, and generic question-answering (QA) systems. LLMs enable these systems to understand and generate responses to a broad range of queries, making them integral to applications like virtual assistants and chatbots.

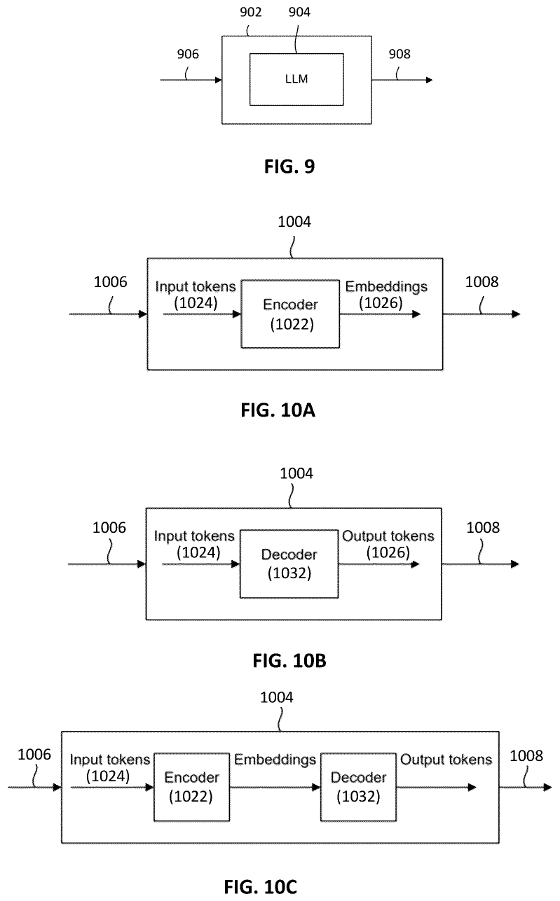

As shown in FIG. 9, the AI engine 902 comprises a FM such as an LLM 904 (which is used as an example in the following description) for processing input 906 (also called “prompt”; for example, natural language input in the form of text, image, voice, and/or the like), recognizing and interpreting the input 906 for generating the output 908 in suitable forms (for example, in form of text, image, audio, video, and/or the like) as the response to the prompt 906. As those skilled in the art will appreciate, foundation models such as LLMs are neural network models that learn the semantics and syntax of language by encoding (sub) words into vector representations.

More specifically, a FM such as an LLM is a computational model that may rely on a large number of computing parameters to perform general purpose text generation and other language tasks such as text classification. LLMs may obtain these abilities by learning the statistical relationship between language tokens through intensive training procedures. A training procedure of an LLM is a procedure during which an LLM learns the statistical relationship between language tokens, usually through auto-regressive learning on some corpus, e.g., predicting the next token given the previous tokens. During this procedure, the ground truth of the tokens to be predicted is known and the errors between the prediction and the ground truth may be iteratively minimized via back-propagation.

Examples of LLMs include ChatGPT (a generative artificial intelligence chatbot developed by OpenAI of San Francisco, California, USA), GPT-4 (Generative Pre-trained Transformer 4, which is a multimodal large language model created by OpenAI of San Francisco, California, USA), LLAMA (a family of autoregressive large language models released by Meta AI of Astor Place, New York City, New York, USA), and PaLM2 (a transformer-based large language model developed by Google AI of Mountain View, California, USA), which have proven to achieve state-of-the-art (SOTA) performance in various natural language processing (NLP) tasks.

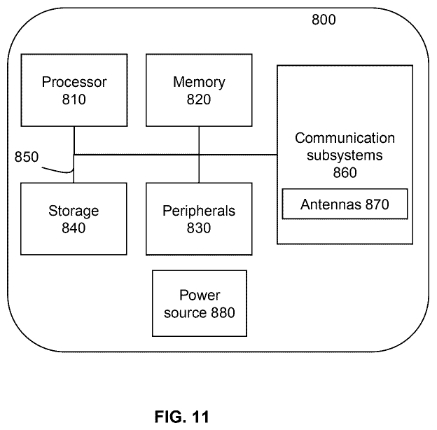

FIGS. 10A to 10C are schematic diagrams showing different types of LLM 1004. These figures are simplified diagrams for showing the different types of LLM 1004 only, and those skilled in the art will understand that the LLM 1004 may also comprise other functional modules that are not shown in these figures.

FIG. 10A shows an encoder-based LLM 1004 comprising an encoder 1022 which processes the input tokens 1024 (which are the units (for example, words or characters partitioned from the prompt 1006) and generates embeddings 1026 (which are then used to generate the output 1008). As those skilled in the art understand, embeddings are high-dimensional vectors encoding semantic contexts and relationships of data tokens.

Most popular LLMs 1004 are decoder-based (or “decoder-only”) models. As shown in FIG. 10B, the LLM 1004 may be an LLM comprising a decoder 1032 which processes the input tokens 1024 and generates output tokens 1036 (which are then used to generate the output 1008). More specifically, the decoder-only LLM 1004 learns to produce a distribution for the next token in a sequence given past context as input.

As shown in FIG. 10C, the LLM 1004 may be an encoder-decoder-based LLM comprising an encoder 1022 which processes the input tokens 1024 and generates embeddings 1026, and a decoder 1032 which generates output tokens 1036 based on the embeddings 1026 (which are then used to generate the output 1008).

The above functionality may be implemented on any one or combination of computing devices. FIG. 11 is a block diagram of a computing device 800 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 800 may comprise a processor 810, memory 820, a mass storage device 840, and peripherals 830. Peripherals 830 may comprise, amongst others one or more input/output devices, such as a speaker, microphone, mouse, touchscreen, keypad, keyboard, printer, display, network interfaces, and the like. Communications between processor 810, memory 820, mass storage device 840, and peripherals 830 may occur through one or more buses 850.

The bus 850 may be one or more of any type of several bus architectures including a memory bus or memory controller, a peripheral bus, video bus, or the like. The processor 810 may comprise any type of electronic data processor. The memory 820 may comprise any type of system memory such as static random-access memory (SRAM), dynamic random-access memory (DRAM), synchronous DRAM (SDRAM), read-only memory (ROM), a combination thereof, or the like. In an embodiment, the memory 820 may include ROM for use at boot-up, and DRAM for program and data storage for use while executing programs.

The mass storage device 840 may comprise any type of storage device configured to store data, programs (e.g. instructions or code), and other information and to make the data, programs, and other information accessible via the bus. The mass storage device 840 may comprise, for example, one or more of a solid-state drive, hard disk drive, a magnetic disk drive, an optical disk drive, or the like. The memory 820 or mass storage 840 may store instructions, which when executed by a processor or processing unit, cause or configure the computing device 800 to perform any of the methods described herein.

Computing device 800 may further comprise a communications subsystem 860 for communicating with other computing devices or for connecting computing device 800 to a computer network. Communications subsystem 860 may comprise one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas 870 and one or more receivers/receive antennas 870. In an embodiment, the processing unit is coupled to a local-area network or a wide-area network, for data processing and communications with remote devices, such as other processing units, the Internet, remote storage facilities, or the like.

Computing device may further comprise a power source 880.

The present disclosure may be implemented on a computing device such as exemplary computing device 800. Computing device 800 may be a network element of a telecommunications network, such that the network element may be connected to other network elements of the telecommunication network, where all network elements form the telecommunication network. The network element may also receive communications from client devices connected to the telecommunication network and provide services to such client devices.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in transitory/non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A method for correcting an original text comprising:
receiving a command in natural language;
determining that the command is a correction command;
classifying the correction command as an addition, a replacement, or a deletion;
when the correction command is an addition or a replacement, determining new text based on the correction command;
determining a correction location in the original text; and
performing the correction to the original text.

2. The method of claim 1, wherein said determining that the command is a correction command comprises detecting an explicit indication during said receiving the command.

3. The method of claim 2, wherein the explicit indication is a button press.

4. The method of claim 1, wherein said determining that the command is a correction command comprises:
providing the original text and the command to a first Large Language Model (LLM); and
determining that the command is a correction command based on an output of the first LLM.

5. The method of claim 4, wherein said determining that the voice command is a correction command comprises detecting a cursor movement to a portion of the original text, the method further comprising providing the cursor movement to the first LLM.

6. The method of claim 1, further comprising determining a description type for the command, the description type being one of structural, contextual, semantic, or augmented-retrieval.

7. The method of claim 6, wherein said determining the description type comprises:
providing the original text, and the correction command to a first Large Language Model (LLM); and
determining a description type for the voice command based on an output of the first LLM.

8. The method of claim 6, wherein said determining the new text comprises:
when the description type is structural:
providing the command to a first Large Language Model (LLM) for extracting structure and pronunciation information from the voice command; and
looking up a structural database based on the structure and pronunciation information.

9. The method of claim 8, wherein the structural database is a dictionary.

10. The method of claim 8, wherein the structural database is a character database.

11. The method of claim 6, wherein said determining the new text comprises:
when the description type is contextual:
providing the command to a first Large Language Model (LLM) for extracting contextual words from the command;
extracting pronunciation information from the command; and
selecting the new text from the command based on the contextual words and the pronunciation information.

12. The method of claim 11, wherein selecting the new text comprises:
finding candidate words which match the pronunciation information;
computing a contextual affinity between the candidate words and the contextual words; and
selecting as the new text the candidate words with the greatest contextual affinity with the contextual words.

13. The method of claim 12, wherein computing the contextual affinity comprises using at least one of a second Large Language Model (LLM) or a word and phrase database.

14. The method of claim 6, wherein said determining the new text comprises:
when the description type is semantic:
providing the command to a first Large Language Model (LLM) for extracting semantic information from the command;
extracting pronunciation information from the command;
finding candidate words which match the pronunciation information;
querying the first Large Language Model to identify candidate words which match the semantic information; and
selecting as the new text the candidate words which match the semantic information.

15. The method of claim 6, wherein said determining the new text comprises:
when the description type is augmented-retrieval:
providing the command to a first Large Language Model (LLM) for extracting information identifying a digital object from the command;
extracting pronunciation information from the command;
retrieving the digital object; and
analyzing the digital object to determine the new text.

16. The method of claim 14, wherein the digital object is a phonebook application and said analyzing the digital object comprises matching text fields from entries in the phonebook application to the pronunciation information.

17. The method of claim 14, wherein the digital object is an image and said analyzing the digital object comprises:
providing the image to an object detection model to identify names of objects in the image;
matching the names of the objects in the image to the pronunciation information.

18. The method of claim 1, wherein said determining the correction location comprises:
identifying a cursor position relative to a portion of the original text.

19. A computing device comprising:
a processor; and
memory;
wherein the computing device is configured to:
receive a command;
determine that the command is a correction command;
classify the correction command as an addition, a replacement, or a deletion;
when the correction command is an addition or a replacement, determine new text based on the correction command;
determine a correction location in the original text; and
perform the correction to the original text.

20. A non-transitory computer readable medium having stored thereon executable code for execution by a processor of a computing device, the executable code comprising instructions for:
receiving a command;
determining that the command is a correction command;
classifying the correction command as an addition, a replacement, or a deletion;
when the correction command is an addition or a replacement, determining new text based on the correction command;
determining a correction location in the original text; and
performing the correction to the original text.
